(19) United States
(12) Patent Application Publication
(10) Pub. No.: US 2025/0306192 A1
(43) Pub. Date: Oct. 2, 2025

(54) WIRELESS COMMUNICATION ARCHITECTURE WITH INTEGRATED RADAR FUNCTIONALITY

(71) Applicant: Amazon Technologies, Inc., Seattle, WA (US)

(72) Inventors: Durga Laxmi Narayana Swamy Inti, San Jose, CA (US); Ravi Ichapurapu, Morgan Hill, CA (US); Morris Yuanhsiang Hsu, Mountain View, CA (US); Maqsood Ahamed Abdul Careem, Sunnyvale, CA (US); Eugene Ren, Palo Alto, CA (US)

(21) Appl. No.: 18/622,765

(22) Filed: Mar. 29, 2024

(51) Int. Cl. G01S 13/04; G01S 7/35; G01S 13/34

(52) U.S. Cl. CPC G01S 13/04; G01S 7/356; G01S 13/34

(57) ABSTRACT

Technologies directed to providing a wireless chipset with integrated radar for presence detection and localization are described. A first wireless device uses a transmit (TX) chain to send data to a second wireless device. The first wireless device generates a chirp signal and uses the TX chain to send the chirp signal. A receive (RX) chain of the first wireless device receives reflected signals corresponding to the chirp signal. The first wireless device determines digital values using the reflected signals and the chirp signal. The first wireless device determines that an environment in which the first wireless device is located has been disrupted by an object using the digital values.

### BACKGROUND

A large and growing population of users is enjoying entertainment through the consumption of digital media items, such as music, movies, images, electronic books, and so on. The users employ various electronic devices to consume such media items. Among these electronic devices (referred to herein as endpoint devices, user devices, clients, client devices, or user equipment) are electronic book readers, cellular telephones, personal digital assistants (PDAs), portable media players, tablet computers, netbooks, laptops, and the like. These electronic devices wirelessly communicate with a communications infrastructure to enable the consumption of digital media items. These electronic devices include one or more antennas to wirelessly communicate with other devices.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram of a wireless device with a baseband processor with integrated radio and radar functionality, according to one embodiment.

FIG. 2 is a block diagram of a wireless device with a chirp generator and digital dechirping logic, according to one embodiment.

FIG. 3 is a block diagram of a wireless device with analog dechirping logic, according to one embodiment.

FIG. 4 is a flowchart illustrating a method of switching between a radio mode and a radar mode, according to one embodiment.

FIG. 5 is a flowchart illustrating a method of determining a presence or movement of a person or other object operation using radar data, according to one embodiment.

FIG. 6 illustrates a method 600 in accordance with one embodiment.

FIG. 7 is a block diagram of a wireless device with radio logic and radar logic, according to one embodiment.

### DETAILED DESCRIPTION

Technologies directed to providing a wireless chipset with integrated radar for presence detection and localization are described. Some sensing capabilities that may be used to provide natural and ambient interactions with a device are cameras, passive infrared (PIR), ultrasonic presence detection (USPD), Wi-Fi® Channel State Information (CSI) based sensing, and radar. However, cameras have privacy concerns and static presence detection using PIR/USPD is difficult. USPD cannot be enabled on products without a speaker and a microphone array for operation. Additionally, while CSI-based sensing does not require additional hardware and can work on any Wi-Fi-enabled device, there can be significant drawbacks. CSI-sensing solutions can detect false positives caused by inanimate objects. CSI-sensing solutions do not provide location information and cannot be used for room-level detection with a single device as it is impossible to identify a side of a link (i.e., Access Point (AP) side or device side) where motion happened. As such, a radar solution is left as the option. However, cost of the standalone radar solutions (e.g., a mmWave radar unit) may pose limits to integrating radar capabilities into products produced at a high volume.

Aspects and embodiments of the present disclosure overcome these deficiencies and others by reusing radio hardware (e.g., Wi-Fi®/Bluetooth® transmit (Tx) and receive (Rx) chains) to mimic traditional radar operation for presence detection. Aspects and embodiments of the present disclosure provide an integrated radar (e.g., frequency modulated continuous wave (FMCW) radar) in a wireless chipset, such as one that implements the Wi-Fi® and/or Bluetooth® technologies (hereinafter wireless chipset). The integrated radar in the wireless chipset re-uses the Wi-Fi®/Bluetooth® transmit chain for radar transmissions for sending chirps and a dedicated receive (RX) chain for receiving reflected signals from the chirps for the presence and localization of a user. The integrated radar may utilize digital dechirping techniques to determine presence or location information. Radar capability on the wireless connectivity solution provides credible presence or location information with minimal additional costs and creates opportunities for sensor fusion with other modalities. Aspects and embodiments of the present disclosure can enable low-cost ambient experience on wireless devices using radar integrated on Wi-Fi® chipsets without having the need for any other sensors.

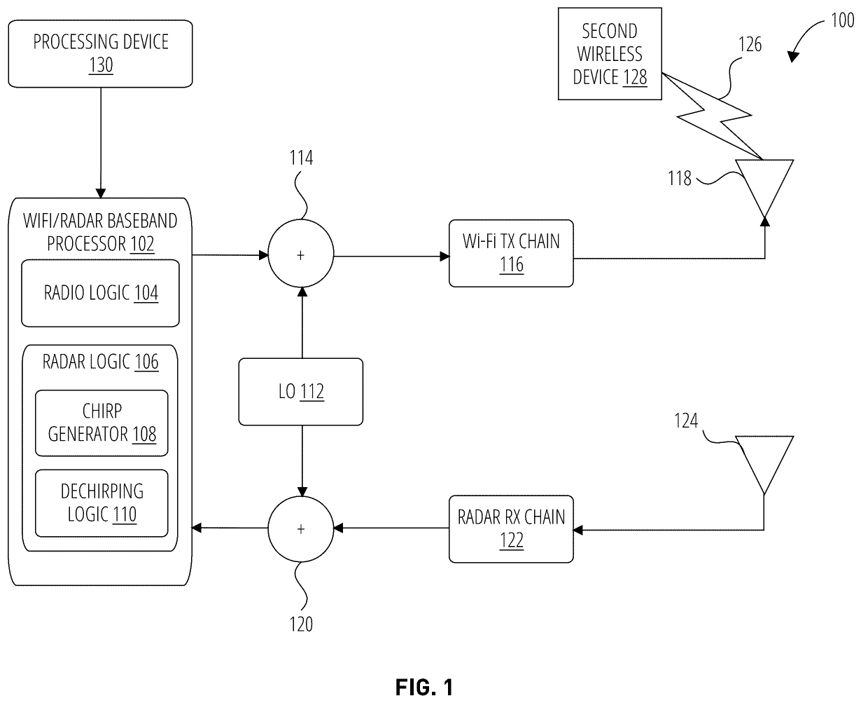

FIG. 1 is a block diagram of a wireless device 100 with a baseband processor 102 with integrated radio and radar functionality, according to one embodiment. The wireless device 100 includes the baseband processor 102, a local oscillator (LO) 112, a first mixer 114, a Wi-Fi transmission (TX) chain 116, a first antenna 118, a second mixer 120, an RX chain 122, and a second antenna 124. The baseband processor 102 can be a wireless chipset coupled to a host device.

In at least one embodiment, the baseband processor 102 is a System on Chip (SoC) that manages, among other things, the wireless protocol of a radio and possibly other aspects of the behavior and operation of the wireless device 100. The wireless device 100 can also include a host processor that controls the operations of the baseband processor 102 and other operations of the wireless device 100. The baseband processor 102 can control radio operations to communicate with one or more devices over one or more communication links. The baseband processor 102 can implement the Wi-Fi® technology, the Bluetooth® technology, or both. Alternatively, the baseband processor 102 can implement other radio technologies. The baseband processor 102 can be any type of processing device, such as a digital signal processor (DSP), an application-specific integrated circuit (ASIC), a field-programmable gate array, or any other type of processing device with radio functionality. In at least one embodiment, the baseband processor 102 can include radio logic 104 and radar logic 106. The radio logic 104 can be a radio subsystem of the baseband processor 102 and the radar logic 106 can be a radar subsystem of the baseband processor 102. In some embodiments, the radar logic 106 can include a chirp generator 108 and dechirping logic 110.

In at least one embodiment, the baseband processor 102 is coupled to the first antenna 118. The baseband processor 102 can drive the first antenna 118 using one or more radio frequency (RF) signals in an RF path, including at least the Wi-Fi TX chain 116. A current flow on the RF path can induce current on the first antenna 118 to cause the first antenna 118 to radiate electromagnetic energy. The baseband processor 102 can also receive RF signals, received as electromagnetic energy by a second antenna 124, in an RF path, including at least the RX chain 122. In some embodiments, the RX chain 122 can be a dedicated RX path for radar operations and a separate RX chain can be used for receiving other RF signals, such as wireless communications sent to the wireless device 100. In other embodiments, the RX chain 122 may be configured to both receive RF signals for both wireless communication operations and radar operations. In some cases, the RF signals are received on the same first antenna 118. The first antenna 118 and the second antenna 124 can be any type of antenna, such as a monopole, a loop, a patch, a slot, or the like. The baseband processor 102 can cause the first antenna 118 and second antenna 124 to radiate and receive electromagnetic energy in a specified frequency range, such as the 2.4 GHz frequency band for wireless personal area network (WPAN) applications (e.g., Bluetooth® Classic or Bluetooth® Low Energy (BLE) technology), wireless local area network (WLAN) applications (e.g., Wi-Fi® technology), or the like. In one embodiment, an operating frequency of the baseband processor 102 is a wide area network (WAN) frequency band (e.g. 5G, Long Term Evolution (LTE) technology, or the like).

During operation, the baseband processor 102 can establish a wireless connection 126 with a second wireless device 128 over a channel using a wireless local area network (WLAN) protocol (e.g., Wi-Fi® protocol). The radar logic 106 can be a radar unit that is integrated in the same integrated circuit as the radio logic 104. The radio logic 104 implements the radio functionality of the wireless device 100 for communicating with other wireless devices, including the second wireless device 128. The radar logic 106 implements the radar functionality of the wireless device 100 for presence and localization operations described herein.

In at least one embodiment, the first mixer 114, the Wi-Fi TX chain 116, the LO 112, the second mixer 120, and the RX chain 122 can be part of radio frequency front-end (RFFE) circuitry. The Wi-Fi TX chain 116 can include components involved in generating and transmitting radio frequency (RF) signals. The Wi-Fi TX chain 116 can be calibrated to ensure accurate and reliable signal transmission. For example, the Wi-Fi TX chain 116 can include power amplifiers, filters, and frequency synthesizers. Calibrating the TX chain helps ensure accurate and reliable signal transmission for either wireless communication or radar operations. A first set of parameters can be determined and used for transmitting and receiving RF signals for RF communications. For example, the first set of parameters may control a power output of an orthogonal frequency-division multiplexing (OFDM) signals used for transmitting and receiving RF signals for RF communications. A second set of parameters can be determined and used for radar functionality as described in more detail below. The second set of parameters can be calibration values for RF front-end calibration, gain and phase calibration, in-phase and quadrature (IQ) imbalance calibration, pre-distortion calibration, carrier frequency calibration, antenna calibration, time alignment calibration, direct current (DC) offset calibration, temperature compensation, or the like. Calibration in the Wi-Fi TX chain 116 is typically performed during a manufacturing process or periodically during operation to maintain system performance over time. It is crucial for meeting regulatory requirements, achieving high-quality communication, and minimizing interference with other wireless systems. Calibration algorithms and methods may vary depending on the specific communication technology and system design.

In some embodiments, the RFFE circuitry can include a digital-to-analog converter (DAC) that can convert digital signals to output analog signals for RF transmissions via the first antenna 118. Similarly, the RFFE circuitry can include an analog-to-digital converter (ADC) that can convert input analog signals into digital signals for processing by the baseband processor 102.

In at least one embodiment, since the radar logic 106 is integrated in the baseband processor 102, the Wi-Fi TX chain 116 can be reused for radar transmissions. In particular, the baseband processor 102 can generate second digital values representing a first baseband signal. The second digital values may be converted into the first baseband signal by a digital-to-analog converter (DAC) (not illustrated in FIG. 1). In some embodiments, the first baseband signal may be a a frequency modulated continuous wave (FMCW) signal that includes a set of chirps. While many types of radar signals may potentially be implemented, FMCW may be chosen due to low complexity and overall compatibility with the existing radio hardware designed for Wi-Fi® operations. In other embodiments, the transmitted RF signal may be another type of RF signal used in radar operations, such as pulse radar, pulse-doppler radar, synthetic aperture radar (SAR), bistatic and multistatic radar, monopulse radar, or the like. The first baseband signal may be combined with an LO signal generated by the LO 112 by the first mixer 114. The resulting mixed signal may be an RF signal that is based on both the LO signal and the first baseband signal. The RF signal may be transmitted through the first antenna 118 into the surrounding environment. The RF signal may be transmitted via the Wi-Fi TX chain 116 and first antenna 118 in a first portion of a frame having a specified frame duration. The transmitted RF signal propagates through space and may encounter various objects (targets) along its path, such as a person. When the transmitted RF signal encounters an object, a portion of the signal is reflected back toward the wireless device 100.

While the first antenna 118 transmits the RF signal, the second antenna 124 may be listening (e.g., observing, receiving) for reflected signals that correspond to the RF signal. The reflected signals may be the RF signal after reflecting off an object or objects (e.g., a person, a car, or another target). The second antenna 124 may provide the reflected signals to the RX chain 122. In at least one embodiment, the RX chain 122 can be a dedicated RX chain for receiving reflected signals from the radar transmissions for presence and localization. In another embodiment, the RX chain 122 may be used for both receiving radio transmissions and radar transmissions. The RX chain 122 may include one or more signal processing hardware components, such as a low noise amplifier (LNA). In some embodiments, the RX chain 122 includes a wideband filter to reduce out-of-band Wi-Fi interference. The RX chain 122 may provide the reflected signals to the second mixer 120. The second mixer 120 may extract a second baseband signal from the reflected signals by mixing the reflected signals with the LO signal. The second baseband signal may be provided to an analog-to-digital converter (ADC) not illustrated in FIG. 1), which converts the second baseband signal into third digital values. The third digital values may be provided to the baseband processor 102, and more particularly, to the dechirping logic 110. The dechirping logic 110 may use the second digital values and the third digital values to generate first digital values. The dechirping logic 110 may digitally mix the second digital values and the third digital values to generate first digital values representing a beat signal, which may represent the difference between the first baseband signal (e.g., original set of chirps) and the second baseband signal (including the reflected set of chirps). The beat signal may include a beat frequency that is proportional to the time delay (Δt) between the transmitted and reflected signals, which is caused by the round-trip propagation time of the chirp. The time delay (Δt) can be related to the physical distance (d) to the target through the formula: d=c*Δt/2, where c is the speed of light. The beat frequency may be indicative of a phase difference between the first baseband signal (represented by the second digital values) and the second baseband signal (represented by the third digital values). By measuring the beat frequency, the radar unit can determine the distance to the target. In some cases, the FMCW radar unit can also detect a Doppler shift caused by moving targets. If a target is moving towards or away from the radar, the reflected signal may experience a frequency shift. By analyzing the frequency shift of the reflected signal, the radar unit can determine the velocity of the target relative to the radar unit. As such, the first digital values may be indicative of a presence or movement of a person or other object in range of the wireless device 100.

In some embodiments, the second digital values, third digital values, and first digital values may be representations (e.g., logarithmic representations) of at least a portion of their respective analog signals (e.g., baseband signals). In other embodiments, the second digital values, third digital values, and first digital values may be IQ samples.

In at least one embodiment, the radio logic 104 and radar logic 106 are integrated in a Wi-Fi® chipset. In at least one embodiment, the radar logic 106 is an FMCW radar unit. FMCW is a type of radar system that uses continuous transmission of frequency-modulated signals to detect and measure the physical distance to objects. The FMCW radar unit may generate a continuous waveform known as a “chirp.” A chirp is a signal that continuously changes frequency over time. The frequency of the chirp increases or decreases linearly with time during each transmission. The chirp waveform typically has a frequency sweep bandwidth (B) and a chirp duration (T). The rate of frequency change (slope) is calculated as the ratio of the bandwidth to the chirp duration (Slope=B/T). The chirp may be generated by the chirp generator 108. In various embodiments, a memory coupled to the chirp generator 108 may store multiple sets of values that each correspond to different chirps of varying bandwidths or durations. In some embodiments, the memory coupled to the chirp generator 108 may store chirps of different shapes or types (e.g., exponential, quadratic, step, hyperbolic, or sawtooth). The memory coupled to the chirp generator 108 may be one or more sets of registers or another memory device. The memory coupled to the chirp generator 108 may be configured for either short or long-term storage. Before generating the second digital values, a set of values corresponding to a desired chirp may be programmed into a programmable buffer (e.g., circular buffer) that employs a rotating index that moves around the buffer to repeatedly access and provide the set of values in a continuous, cyclical manner. By employing the rotating index, the programmable buffer allows chirp generator 108 to repeatedly provide the same chirp over and over within a time window (e.g., the first portion of the frame). In other words, the rotating index allows the chirp generator 108 to provide multiple instances of the same chirp using only enough space on the buffer to store digital values (e.g., IQ samples or other digital values) to store one chirp. The programmable buffer may be implemented in software, firmware, hardware, or any combination thereof.

The slope of the desired chirp may be dependent on a total number of values within the corresponding set of values. For example, a first set of values representing a first chirp having a bandwidth of 150 MHz and a duration of 4 milliseconds (ms) may include twice the number values than a second set of values representing a second chirp having a bandwidth of 150 MHz and a duration of 2 ms.

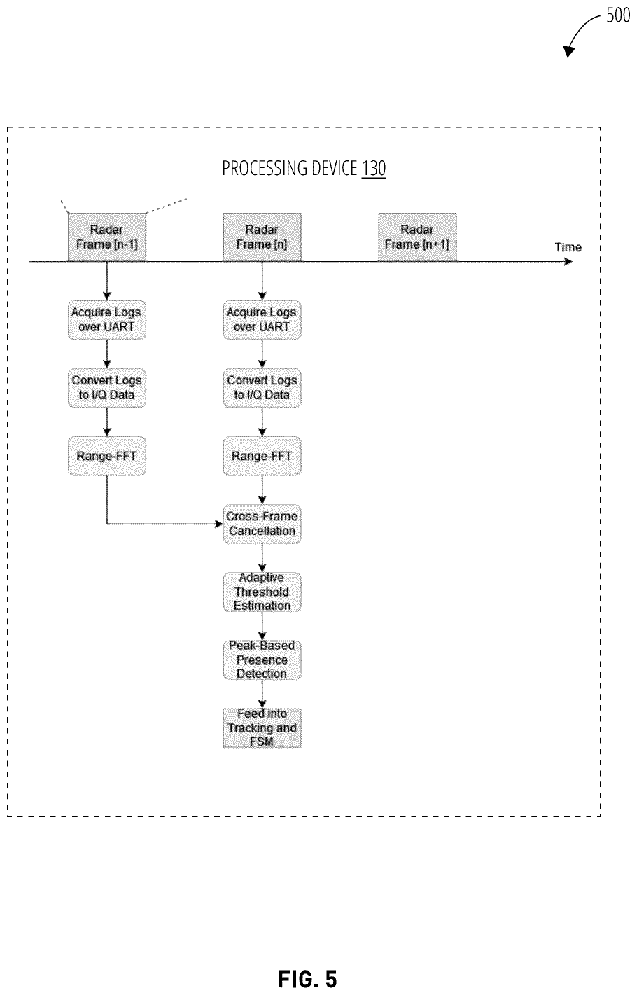

In at least one embodiment, the wireless device 100 includes a processing device 130 coupled to the baseband processor 102. The processing device 130 can receive the first digital values from the radar logic baseband processor 102. The processing device 130 can determine, using the first digital values, that an environment in which the wireless device 100 is located has been disrupted by a presence or motion of a person or other object. The processing device 130 can determine, using the first digital values, a presence of a user in proximity to the wireless device 100. The processing device 130 and how the first digital values are used to determine that the environment has been disrupted by a presence or motion of a person or other object is described in more detail below with respect to FIG. 5.

The presence can be used for subsequent operations by the device, such as operations of an ambient mode. Radar capability on the existing wireless connectivity solution can provide credible presence and location information with minimal additional costs and creates opportunities for sensor fusion with other modalities. The first digital values from the radar logic 106 could be a viable alternative for enabling certain features or modes on low-end devices, such as smart mode or ambient mode. This integrated radar logic 106 can enable these certain features or modes on the wireless device 100 without the need for any additional sensors. In at least one embodiment, the baseband processor 102 sends RF signals generated by both the radar logic 106 and radio logic 104 over the same channel. In another embodiment, the baseband processor 102 sends the RF signals generated by the radar logic 106 in a first channel of a frequency band and sends or receives RF signals generated by the radio logic 104 in a second channel of the frequency band, where the first channel and the second channel are different.

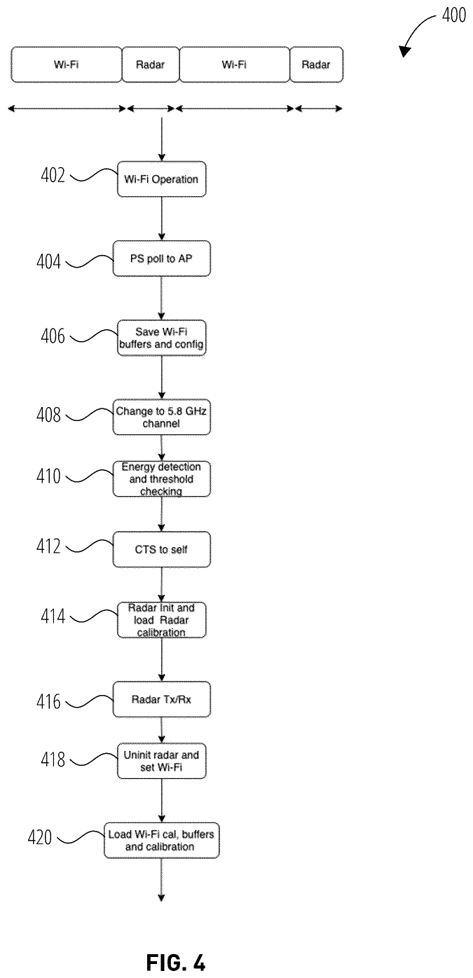

The radar logic 106 (FMCW radar unit) can function in a time-sharing fashion with the radio logic 104. By time-sharing the radar functionality and the radio functionality on the same channel (or a different channel in the frequency band), the host processor can switch between (i) Wi-Fi® (or another type of wireless communication) operations, such as sending and receiving data packets, and (ii) radar operations to determine the presence and localization information to detect presence of a person and determine a physical distance to the person for detection and localization applications. The radio logic 104 and radar logic 106 can be implemented in a Wi-Fi® and Radar co-existence protocol that is designed in a way that it does not impact any of the existing Wi-Fi® standard along with Wi-Fi® use-cases. This co-existence protocol is explained in more detail below with respect to FIG. 4. It should be noted that off-the-shelf Wi-Fi® chips do not have dedicated radar functionality. For these chips, only channel state information (CSI) based sensing is feasible. However, with the radar logic 106 integrated into the Wi-Fi® chipset, the wireless device 100 can use one or more of a radar mode or CSI mode to detect a presence of a person and determine a distance to the person for detection and localization applications. In some embodiments, the inclusions of the radar functionality and sensor fusion algorithms, as described herein, with CSI data, can enable new use cases and improve accuracy of existing use cases.

While the wireless device 100 as described above is configured for person detection, the wireless device 100 may be used in a number of different environments. For example, in some embodiments, the wireless device 100 may be used to provide a sensing capability for an automobile that determines position and velocity of other automobiles or objects nearby. In these embodiments, the radio logic 104 may provide Bluetooth® or Wi-Fi® connectivity within the automobile while the radar logic 106 provides the sensing capability. Other use cases where the present disclosure may be implemented may include, but is not limited to, security applications (e.g., doorbell cameras or other motion detection devices), geofencing (e.g., triggering certain actions or location services based a boundary and a location of an object or person), or other applications that utilize radar or passive infrared (PIR) to detect motion or presence of an object or person.

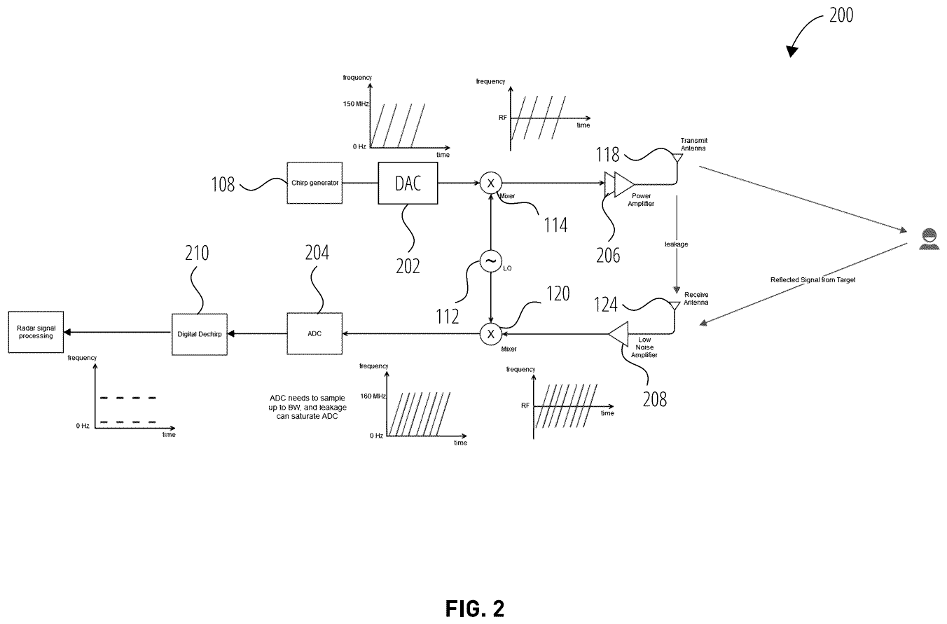

FIG. 2 is a block diagram of a wireless device 200 with a chirp generator 108 and digital dechirping logic 110, according to one embodiment. The wireless device 200 may include features that are the same or similar to the wireless device 100 as described above with respect to FIG. 1. The wireless device 200 includes at least the chirp generator 108, a DAC 202, the first mixer 114, the LO 112, a power amplifier 206, the first antenna 118, the second antenna 124, an LNA 208, the second mixer 120, an ADC 204, and a digital dechirping logic 210. The digital dechirping logic 210 may include same or similar features to the dechirping logic 110. The chirp generator 108, the DAC 202, the first mixer 114, the LO 112, the power amplifier 206, the first antenna 118 may form a TX chain. The the second antenna 124, the LNA 208, the second mixer 120, the ADC 204, and the digital dechirping logic 210 may form an RX chain.

In some embodiments, as already described, the chirp generator 108 may generate a set of chirps—i.e., a signal that continuously changes frequency over time. The chirp generator 108 may be configured to provide second digital values representing the set of chirps as an FMCW signal. The chirp generator 108 may provide the second digital values to the DAC 202 by employing a programmable buffer with a rotating index, as described above with respect to FIG. 1.

In some embodiments, a power characteristic of the FMCW signal may be different than a signal strength of an orthogonal frequency-division multiplexing (OFDM) signal used during wireless communication. For examples, the OFDM signal may inherently have a high peak-to-average power ratio (PAPR). However, FMCW signals are often employed in radar systems and have a different waveform than OFDM signals. In FMCW, the signal's frequency varies with time to measure the range and velocity of objects with the field of view (FOV) of the radar unit (e.g., the wireless device 200). As such, FMCW signals generally have lower PAPR when compared to OFDM signals because the FMCW itself, which involves a continuous change in frequency over time, generally does not lead to the same peak power characteristics seen in OFDM where the superposition of multiple sub-carrier signals can align to create high peak power. While OFDM and FMCW signal may not have the same PAPR or peak power characteristics, power characteristics of OFDM and FMCW signals may be related by one or more offset power values. As such, the chirp generator 108 may utilize a first look-up table (LUT) including offset values (e.g., offset power values) that represent a difference between FMCW power levels and OFDM power levels. Each of these offset values may correspond to a frequency or frequency range. The offset values may be determined by comparing historical FMCW and OFDM power levels. These offset values may be used to determine what power level an FMCW signal should have at a particular frequency or point in time. In various embodiments, the offset values are a difference between historical FMCW and OFDM power levels at a frequency or frequency range.

At any given frequency, the chirp generator 108 may generate the FMCW signal by combining the OFDM power value and the corresponding offset value from the first LUT.

In some cases, the wireless device 200 may be deployed in an environment with a high noise floor. The high noise floor may be caused by wireless communication traffic within the bandwidth of the set of chirps, the inherent nature of higher frequencies, multipath, high amounts of clutter or the like. So, due to the high noise floor, a high overall signal strength of chirps transmitted by the TX chain may be desired. However, the overall signal strength each chirp may be limited due to leakage (e.g., direct transmission) between the first antenna 118 and the second antenna 124. The leakage may occur due to a lack of full isolation between the first antenna 118 and the second antenna 124. Thus, to avoid the ADC 204 saturating (e.g., the reflected signals being clipped by the ADC 204) due to the leakage, the signal strength of the FMCW signal may be limited. The signal strength of the FMCW signal may also be limited by a higher bandwidth of the reflected signals converted to digital values by the ADC 204 than a bandwidth of the originally transmitted chirp signal. This higher bandwidth may introduce a higher noise floor into the reflected signal, which may cause the signal strength of the FMCW signal to be lower to avoid saturating the ADC 204. The signal strength of FMCW signal may also be limited because the Wi-Fi TX chain 116 is primarily configured for wireless communication, not radar operations. Thus, while a high signal-to-noise ratio (SNR) may be desired, the above problems (and other similar problems) may pose a challenge to raising the SNR of the wireless device 200.

These problems and others may be solved by increasing a number of chirps within the FMCW signal and coherently integrating reflected chirps corresponding to the transmitted chirps. Coherent integration involves summing the reflected chirps coherently (i.e., maintaining the phase information) over multiple pulses or chirps. By averaging the signals, coherent integration enhances the reflected chirps while canceling or reducing noise (e.g., random noise). This results in an improved SNR, making it easier to detect and analyze reflected chirps against the background noise. Thus, a higher number of chirps transmitted and reflected by the wireless device 200 positively correlates with a higher SNR. As such, due to the properties of coherent integration, the SNR of the reflected signals (e.g., as described above with respect to FIG. 1) may depend on a total number of chirps within the overall FMCW signal. For example, a first FMCW signal including twenty chirps over a time window will have a higher SNR than a second FMCW signal including ten chirps over the same time window. Under the same assumption, a high number of chirps within the FMCW signal may be desired to improve SNR, which in turn improves presence detection of the wireless device 300.

While a high bandwidth may also improve SNR, the bandwidth of each chirp may be compliance restricted (e.g., to 150 MHz). For example, regulations imposed by a governing body may only allow radar operations to occur within a set range of frequencies. However, in some embodiments, the bandwidth of each chirp may be larger than 150 MHz. Multiple types of chirps of varying bandwidths, durations, and shapes (e.g., exponential, quadratic, step, hyperbolic, or sawtooth) may be stored in memory units, such as registers, coupled to the chirp generator 108. In some embodiments, at least one type of chirp includes one or more second digital values that would provide a gap between each chirp of the FMCW signal. The chirp generator 108 may receive an indication from upstream circuitry (e.g., a host processor) indicating which type of chirp is to be employed.

The chirp generator 108 may be coupled to a DAC 202. The DAC 202 may generate a first baseband signal (e.g., the FMCW signal, or the set of chirps) using the second digital values provided by the chirp generator 108. The first baseband signal may include at least the features described above with respect to FIG. 1. In some embodiments, the DAC 202 may support a sampling rate higher than what is required for wireless transmission. The chirp generator 108 may take advantage of the supported higher sampling rate to increase bandwidth or reduce transmission time of each chirp of the FMCW signal. The DAC 202 may provide the first baseband signal to the first mixer 114, which creates an RF signal to be transmitted by the first antenna 118 by mixing the FMCW signal with an LO signal generated by the LO 112, as described above with respect to FIG. 1. The RF signal may be amplified by the power amplifier 206 before being transmitted by the first antenna 118.

While the first antenna 118 transmits the RF signal, the second antenna 124 may be listening (e.g., observing, receiving) for reflected signals that correspond to the RF signal. The reflected signals may be the RF signal after reflecting off an object or objects (e.g., a person, a car, or another target). The reflected signals may pass through the LNA 208. In some embodiments, the LNA 208 may be designed to have a wide bandwidth to amplify all frequencies corresponding to the RF signal while also maintaining low noise performance across the range of the LNA 208. The LNA 208 may provide the reflected signals to the second mixer 120 that extracts a second baseband signal (e.g., reflected FMCW signals) from the reflected signals by mixing the reflected signals with the LO signal, as described above with respect to FIG. 1. The second baseband signal may include a set of reflected chirps that corresponds to the set of chirps generated by the chirp generator 108.

In some embodiments, the wireless device 100 may include more than one second antenna 124 that allows the processing device 130 to estimate an angle of arrival (AOA). The wireless device 100 may switch between the multiple second antennas 124 automatically or based on an input of a user, such as by an external switch. In some embodiments, enabling the external switch causes multiple second antennas 124 to both observe the reflected signals concurrently.

The second baseband signal may be provided to the ADC 204, which generates third digital values from the second baseband signal. In some embodiments, as described above, the first antenna 118 and the second antenna 124 are not completely isolated, which may allow a certain amount of leakage (e.g., direct transmission) to occur from the first antenna 118 to the second antenna 124. To avoid saturating the ADC 204, the overall gain of the RX chain may need to be limited. The ADC 204 may provide the third digital values the digital dechirping logic 210.

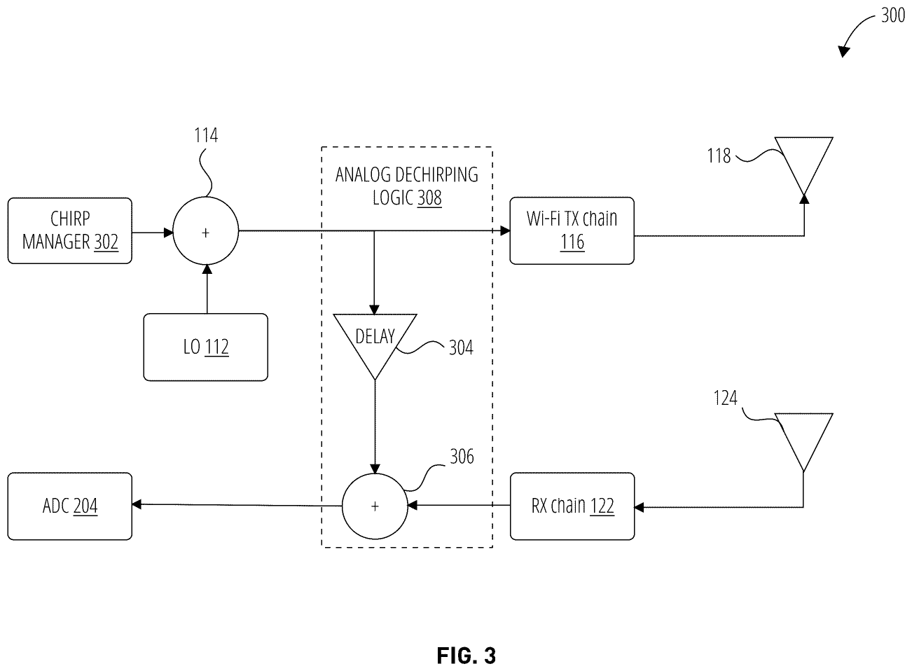

Employing the digital dechirping logic 210 instead of analog dechirping logic (e.g., analog dechirping logic 308 of FIG. 3) to dechirp the second baseband signal (e.g., second baseband signal) can provide certain advantages, such as lower hardware complexity and lower cost implementation. However, employing the dechirping logic 110 digitally may also pose certain challenges. For example, a signal-to-noise ratio (SNR) of a digitally-dechirped signal may be worse than an SNR of a dechirped signal produced by analog dechirping logic. When an analog signal is converted to a digital signal by an analog-to-digital converter (ADC), the continuous signal is quantized to a set of discrete values. This quantization process may introduce quantization noise, which can degrade the SNR. Additionally, digital processing can introduce digital processing noise to the set of discrete values. For example, numerical errors can accumulate in digital filters or transforms like fast Fourier transforms (FFTs). These challenges and other deficiencies may be overcome by increasing a number of chirps transmitted and reflected and utilizing coherent integration, as described above.

The digital dechirping logic 210 may include at least the features of the dechirping logic 110. In some embodiments, the digital dechirping logic 210 may digitally filter any leakage as described above from the third digital values. The digital dechirping logic 210 may filter the leakage by utilizing a second LUT that includes known leakage strengths at different frequencies. The leakage strengths may be known based on (i) a distance between the first antenna 118 and the second antenna 124 and (ii) a signal strength of the RF signal transmitted via the first antenna 118. After digitally filtering leakage caused by the lack of complete isolation between the first antenna 118 and second antenna 124, the digital dechirping logic 210 may digitally mix the second digital values and the third digital values to generate first digital values. The first digital values may represent a beat signal as described above with respect to FIG. 1. The first digital values may be provided to upstream circuitry for further radar signal processing. In some embodiments, the upstream circuitry may be a processing device, such as the processing device 130 of FIG. 1. The further radar signal processing is described in more detail below in FIG. 5.

FIG. 3 is a block diagram of a wireless device 300 with analog dechirping logic 308, according to one embodiment. The wireless device 300 can include a chirp manager 302, the first mixer 114, the Wi-Fi TX chain 116, the first antenna 118, the second antenna 124, the RX chain 122, delay circuitry 304, a second mixer 306, and the ADC 204. The analog dechirping logic 308 may include the delay circuitry 304 and the second mixer 306.

In at least one embodiment, the chirp manager 302 generates a first baseband signal. The first baseband signal may be a set of chirps. In some embodiments, the first baseband signal may include same or similar features as the first baseband signal described above in FIGS. 1-2. In various embodiments, the chirp manager 302 may utilize a phase-locked loop (PLL) to generate the first baseband signal. The first mixer 114 may mix the first baseband signal and an LO signal generated by the LO 112 to form an RF signal. The RF signal may be provided both to the Wi-Fi TX chain 116 and the delay circuitry 304. The Wi-Fi TX chain 116 may provide the RF signal to the 118, which transmits the RF signal to an environment surrounding the wireless device 300. The delay circuitry 304 may delay the RF signal for an amount of time before providing the RF signal to the second mixer 306. The amount of time that the delay circuitry 304 delays the RF signal may be designed to reduce or eliminate leakage (e.g., direct transmission) caused by non-complete isolation between the first antenna 118 and the second antenna 124.

The second antenna 124 and RX chain 122 may receive reflected signals corresponding to the RF signal. The second mixer 306 may extract a second baseband signal by mixing the reflected signals with the delayed RF signal from the delay circuitry 304. The delayed RF signal may be a combination of a delayed chirp signal and a delayed LO signal. The second baseband signal may be provided to the ADC 204, which in turn may generate third digital values representing a beat signal, which may represent the difference between the first baseband signal (e.g., original set of chirps) and the second baseband signal (e.g., reflected set of chirps). As such, the third digital values may be indicative of a presence or movement of a person or other object in range of the wireless device 300. The third digital values may be provided to upstream circuitry (e.g., a host processor or processing device, such as the processing device 130 as described in FIG. 1 and FIG. 4) for further signal processing.

FIG. 4 is a flowchart illustrating a method 400 of switching between a radio mode and a radar mode, according to one embodiment. A radio mode may be a first portion of a time window (e.g., frame) when wireless communication operations are performed. A radar mode may be a second portion of the time window when radar operations are performed. In some embodiments, the switching between radio and radar modes may cause the processing logic to be inoperable for a short period of time. Any period of time short enough to avoid impacting the wireless communication operations of the wireless device may be desired. The method 400 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the processing logic may be the wireless device 100 of FIG. 1, the wireless device 200 of FIG. 2, or the wireless device 300 of FIG. 3. The method 400 can be performed by other devices described herein.

At block 402, the the processing logic may perform Wi-Fi® operation(s) within the radio mode. The Wi-Fi® operation(s) may include communicating with another wireless device by sending or receiving data packets over a channel.

At block 404, the processing logic may send a power save (PS) poll to an access point (AP). The PS poll may indicate to the AP that the processing logic will temporarily not receive any data packets sent by the AP. The AP may store data packets intended for the processing logic until the processing logic indicates to the AP that it is again able to receive data packets. The processing logic may not indicate an active mode to the AP until after saved Wi-Fi® data and configuration(s) are reloaded to the processing logic at block 420.

At block 406, the processing logic may save Wi-Fi® data and configuration(s). The processing logic may store the Wi-Fi® data and configuration(s) by storing them in memory external to the TX or RX chains to ensure that critical information like network credentials, connection parameters, and temporary network data is preserved while the processing logic switches from the radio mode to the radar mode. The saved Wi-Fi® configuration(s) may include a first set of parameters designed for transmitting and receiving RF signals for RF communications. For example, the first set of parameters may control a power output of an orthogonal frequency-division multiplexing (OFDM) signals used for transmitting and receiving RF signals for RF communications.

At block 408, the processing logic may change a channel. For example, during radio mode, the processing logic may wirelessly communicate with surrounding wireless devices part of a wireless local area network (WLAN) using typical channels (e.g., channels 1, 6, and 11 of the 2.4 GHz band). However, due to high amounts of wireless communication traffic in these channels, radar operations may not be optimized if performed on these same typical channels. As such, the processing logic may switch to a channel not typically used for wireless communication (e.g., 5.8 GHz channel, or channel 160 of the 5 GHz band) when switching from the radio mode to the radar mode. Additionally, a bandwidth of a channel used during radio mode may not be the same as a bandwidth of a channel used during radar mode.

At block 410, before initializing the radar mode and loading the radar calibration(s), the processing device may verify whether a high energy signature is observed by an antenna (e.g., the second antenna 124) within the frequency channel selected by the processing logic at block 408. The processing logic may compare the energy signature observed by the antenna to a threshold. The radar mode may be initialized in response to determining that the energy signature is below the threshold. If the energy signature is above the threshold (e.g., does not satisfy the threshold), the processing logic may repeatedly compare the energy signature to the threshold until the energy signature is below a threshold (e.g., satisfies the threshold). In at least some embodiments, this threshold may be set at between −60 and −65 decibel milliwatts (dBm). In some embodiments, if the threshold is not satisfied the first time, the processing logic may repeatedly verify the energy signature observed by the antenna until the second portion of the time window has expired. Once the time window has expired, the processing logic may revert back to the radio mode and load the Wi-Fi® data and calibration(s) at block 420 until the first portion of a subsequent time window has expired (e.g., until the next time the processing logic is to switch from the radio mode to the radar mode).

At block 412, the processing logic may initialize a clear to send (CTS) signal that is sent to itself. The CTS signal may be sent in order to initialize the radar mode.

At block 414, the processing logic initializes the radar mode and loads the radar calibration(s). The radar calibration(s) loaded may include a second set of parameters that can be determined and used for radar functionality. The second set of parameters can be calibration values for RF front-end calibration, gain and phase calibration, in-phase and quadrature (IQ) imbalance calibration, pre-distortion calibration, carrier frequency calibration, antenna calibration, time alignment calibration, DC offset calibration, temperature compensation, or the like. In at least one embodiment, the first set of parameters (e.g., radio mode parameters) has a first parameter that indicates a first transmit power level of the TX chain, and the second set of parameters (e.g., radar mode parameters) has a second parameter that indicates a second transmit power level of the TX chain. In another embodiment, the first set of parameters includes a first parameter that indicates a first calibration value of a component of the TX chain or the RX chain, and the second set of parameters includes a second parameter that indicates a second calibration value of the component.

At block 416, the processing logic perform one or more radar operations. Each radar operation may include (i) transmitting an RF signal including a set of chirps and (ii) receiving reflected signals including a reflected set of chirps corresponding to the set of chirps of the RF signal. Additionally, each radar operation may also include generating digital values indicative of a presence or movement of a person or other object within the field of view of antenna(s) coupled to the processing logic.

At block 418, the processing logic initiates a switch back to the radio mode from the radar mode.

At block 420, the processing logic reloads the Wi-Fi® data and configuration(s) store at block 406.

FIG. 5 is a flowchart illustrating a method 500 of determining a presence or movement of a person or other object operation using radar data, according to one embodiment. The method 500 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the processing logic may be the processing device 130 of FIG. 1. In some embodiments, the method 500 may be performed by the wireless device 100 of FIG. 1, the wireless device 200 of FIG. 2, or the wireless device 300 of FIG. 3. The method 500 can be performed by other devices described herein.

As described above in FIG. 4, each time window may include a first portion for radio operations (radio mode) and a second portion for radar mode (radar operations). In some embodiments, the time windows may be time transmission intervals (TTI). As illustrated in FIG. 5, each radar frame may correspond to one time window. Each radar frame includes one set of data (e.g., range fast Fourier transform (range-FFT)). As such, in at least one embodiment, one set of radar data may be generated during a time window.

In some embodiments, a wireless device acquires a first set of values (e.g., logs) for a first radar frame. This first set of values may be a representation of a difference between an original set of chirps transmitted by the wireless device and a reflected set of chirps received by the wireless device. In some embodiments, this first set of values represents a beat signal as described above with respect to FIGS. 1-3. The wireless device may convert this first set of values into in-phase and quadrature (IQ) samples which are thereafter passed through a range-FFT. The range-FFT transforms the first set of values in the time domain into a second set of values in the frequency domain. The each of the second set of values may correspond to a different frequency bin (e.g., frequency range) and indicate a strength or intensity of reflected signals from an object at that corresponding frequency bin.

Subsequent to acquiring the first set of values for a first radar frame, the wireless device may acquire a third set of values for a second radar frame (e.g., for a subsequent time window). The wireless device may generate a fourth set of values using the third set of values in a manner similar to how the wireless device generates the second set of values using the first set of values described above.

After generating the fourth values, the wireless device may perform a cross-frame cancellation by comparing the fourth set of values to the second set of values. The wireless device may perform the cross-frame cancellation by comparing values of the second set of values and the fourth set of values that correspond to a same distance bin. The cross-frame cancellation may generate a fifth set of values. Each value of the fifth set of values may be equal to difference between a value of the second set of values and a value of the fourth set of values that each correspond to the same distance bin. Any non-zero (or non-negligible) value of the the fifth set of values may be indicative of a presence or movement of a person or other object in range of the wireless device 100.

While the above description describes a cross-frame cancellation between two radar frames, one of skill in the art would appreciate that multiple past radar frames may be used in lieu of a single past radar frame (e.g., the first radar frame). For example, the fourth set of values described above may be compared to another set of values corresponding to average of any number of past radar frames.

To determine whether any value of the fifth set of values is indicative of a presence or movement of a person or object, the wireless device may compare the fifth set of values to a threshold. In some embodiments, the threshold may be an adaptive or dynamic threshold that accounts for sets of values corresponding to any number of past radar frames. In other embodiments, the threshold may be a fixed amount that prevents further signal processing if none of the values within the fifth set of values is significant (e.g., non-negligible). Here, a value may be significant if the value provides any indication of a presence or movement of a person or object.

If at least one value of the fifth set of values is considered significant, the wireless device may determine that there is at least a static presence of an object (e.g., a person) within range (e.g., FOV). Once static presence has been verified, the wireless device may perform a peak-based presence detection operation to determine a dynamic presence (e.g., motion) of the object. The peak-based presence detection operation may include determining which frequency bin(s) have peaks (e.g., local or absolute maximum) within the fifth set of values. In some embodiments, the wireless device only identifies a highest peak (e.g., absolute maximum) within the fifth set of values. In other embodiments, the wireless device may identify all peaks within the fifth set of values that are over a predetermined threshold. The identified peaks may be recorded and provided to other functionalities of the wireless device, such as a tracking function that tracks movement and presence information gathered and processed by the features and components described herein.

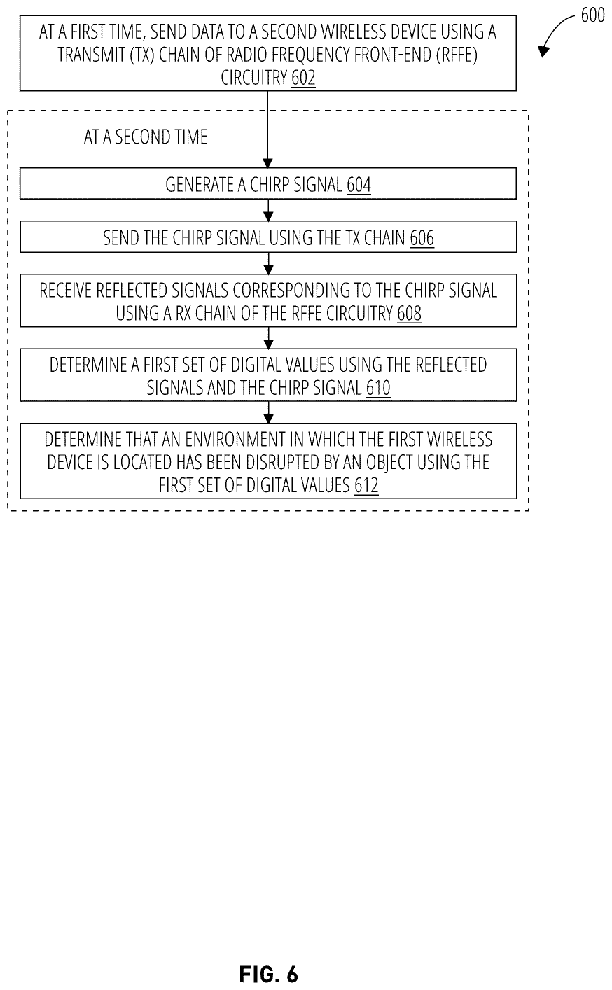

FIG. 6 is a method 600 of operating a wireless device, according to one embodiment. The method 600 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the processing logic may be the wireless device 100 of FIG. 1. In some embodiments, the method 600 may be performed by the wireless device 200 of FIG. 2 or the wireless device 300 of FIG. 3. The method 600 can be performed by other devices described herein.

At block 602, the processing logic sends data to a second wireless device using a transmit (TX) chain of radio frequency front-end (RFFE) circuitry. The processing logic may send data to the second wireless device at a first time. Subsequent blocks 604, 606, 608, 610, and 612 may be performed at a second time different than the first time.

At block 604, the processing logic generates a chirp signal.

At block 606, the processing logic sends the chirp signal using the TX chain.

At block 608, the processing logic receives reflected signals corresponding to the chirp signal using a RX chain of the RFFE circuitry.

At block 610, the processing logic determines a first set of digital values using the reflected signals and the chirp signal.

At block 612, the processing logic determines that an environment in which the first wireless device is located has been disrupted by an object using the first set of digital values.

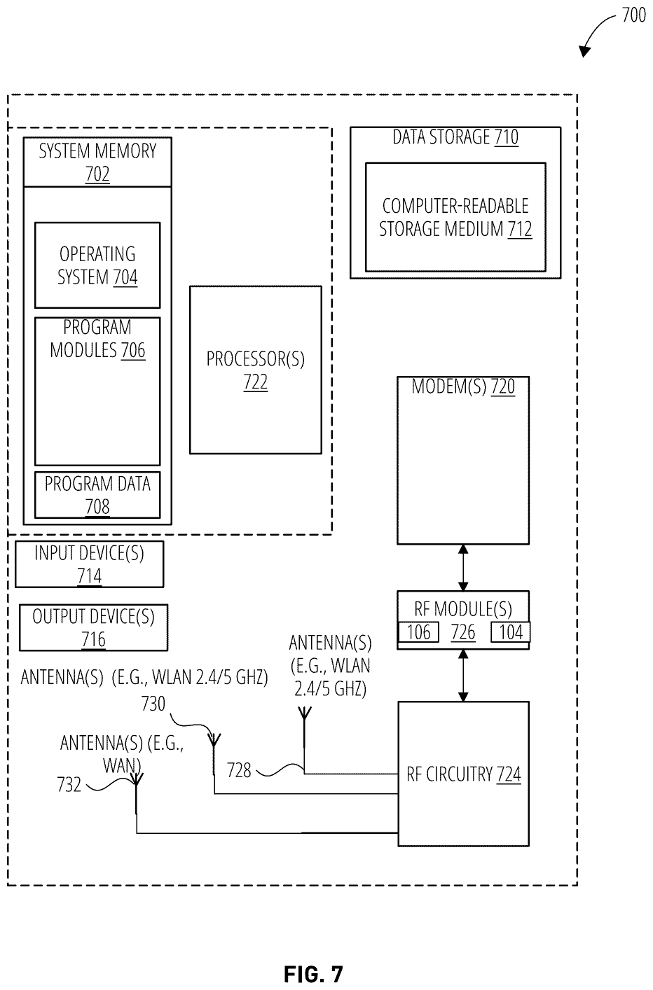

FIG. 7 is a block diagram of a wireless device 700 with integrated radio and radar functionality according to one embodiment. The wireless device 700 may correspond to the any devices described above with respect to FIG. 1 to FIG. 5. In the depicted embodiment, the wireless device 700 includes the radar logic 106 and radio logic 104. Alternatively, the wireless device 700 may be other electronic devices, as described herein.

The wireless device 700 includes one or more processor(s) 722, such as one or more CPUs, microcontrollers, field-programmable gate arrays, or other types of processors. The wireless device 700 also includes system memory 702, which may correspond to any combination of volatile and/or non-volatile storage mechanisms. The system memory 702 stores information that provides operating system 704, various program modules 706, program data 708, and/or other components. In one embodiment, the system memory 702 stores instructions of methods to control the operation of the wireless device 700. The wireless device 700 performs functions by using the processor(s) 722 to execute instructions provided by the system memory 702.

The wireless device 700 also includes a data storage device 710 that may be composed of one or more types of removable storage and/or one or more types of non-removable storage. The data storage device 710 includes a computer-readable storage medium 712 on which is stored one or more sets of instructions embodying any of the methodologies or functions described herein. Instructions for the program modules 706 may reside, completely or at least partially, within the computer-readable storage medium 712, system memory 702, and/or within the processor(s) 722 during execution thereof by the wireless device 700, the system memory 702 and the processor(s) 722 also constituting computer-readable media. The wireless device 700 may also include one or more input device(s) 714 (keyboard, mouse device, specialized selection keys, etc.) and one or more output device(s) 716 (displays, printers, audio output mechanisms, etc.).

The wireless device 700 further includes one or more modem(s) 720 to allow the wireless device 700 to communicate via wireless connections (e.g., such as provided by the wireless communication system) with other computing devices, such as remote computers, an item providing system, and so forth. The modem(s) 720 can be connected to one or more radio frequency (RF) modules 726. The RF module(s) 726 may be a WLAN module, a WAN module, a wireless personal area network (WPAN) module, a Global Positioning system (GPS) module, or the like. The antenna structures (antenna(s) 728, 730, 732) are coupled to the RF circuitry 724, which is coupled to the modem(s) 720. The RF circuitry 724 may include radio front-end circuitry, antenna switching circuitry, impedance matching circuitry, or the like. The antenna(s) 728, 730, 732 may be GPS antennas, a near field communication (NFC) antennas, other WAN antennas, WLAN or PAN antennas, or the like. The modem(s) 720 allows the wireless device 700 to handle both voice and non-voice communications (such as communications for text messages, multimedia messages, media downloads, web browsing, etc.) with a wireless communication system. The modem(s) 720 may provide network connectivity using any type of mobile network technology including, for example, cellular digital packet data (CDPD), general packet radio service (GPRS), EDGE, universal mobile telecommunications system (UMTS), 1 times radio transmission technology (1×RTT), evaluation data optimized (EVDO), high-speed downlink packet access (HSDPA), Wi-Fi®, Long Term Evolution (LTE) and LTE Advanced (sometimes generally referred to as 4G), etc.

The modem(s) 720 may generate signals and send these signals to the antenna(s) 728 of a first type (e.g., WLAN 5 GHz), antenna(s) 730 of a second type (e.g., WLAN 2.4 GHz), and/or antenna(s) 730 of a third type (e.g., WAN), via RF circuitry 724, and RF module(s) 726 as described herein. Antenna(s) 728, 730, 732 may be configured to transmit in different frequency bands and/or using different wireless communication protocols. The antenna(s) 728, 730, 732 may be directional, omnidirectional, or non-directional antennas. In addition to sending data, antenna(s) 728, 730, 732 may also receive data, which is sent to appropriate RF modules connected to the antennas. One of the antenna(s) 728, 730, 732 may be any combination of the antenna structures described herein.

In one embodiment, the wireless device 700 establishes a first connection using a first wireless communication protocol, and a second connection using a different wireless communication protocol. The first wireless connection and second wireless connection may be active concurrently, for example, if a wireless device is receiving a media item from another wireless device (e.g., a mini-POP node) via the first connection) and transferring a file to another electronic device (e.g., via the second connection) at the same time. Alternatively, the two connections may be active concurrently during wireless communications with multiple devices. In one embodiment, the first wireless connection is associated with a first resonant mode of an antenna structure that operates at a first frequency band and the second wireless connection is associated with a second resonant mode of the antenna structure that operates at a second frequency band. In another embodiment, the first wireless connection is associated with a first antenna structure and the second wireless connection is associated with a second antenna. In other embodiments, the first wireless connection may be associated with content distribution within mesh nodes of a wireless mesh network and the second wireless connection may be associated with serving a content file to a client consumption device, as described herein.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A first wireless device comprising:
a first antenna;
a second antenna;
a processing device;
a baseband processor comprising radio logic and radar logic, wherein the baseband processor is coupled to the processing device, the first antenna, and the second antenna, and wherein the first wireless device is configured to establish, using the radio logic, a wireless connection with a second wireless device;
radio frequency front-end (RFFE) circuitry comprising a transmit (TX) chain coupled to the first antenna and a receive (RX) chain coupled to the second antenna; and
a local oscillator (LO) coupled to the TX chain by a first mixer and coupled to the RX chain by a second mixer, wherein the LO generates an LO signal, and wherein the first wireless device is configured to
generate, using the radar logic, a first baseband signal comprising a set of chirps;
generate, using the first mixer, a first RF signal by mixing the first baseband signal with the LO signal;
send, via the TX chain, the first RF signal;
receive, via the RX chain, a second RF signal comprising reflected signals corresponding to the first RF signal;
generate, using the second mixer, a second baseband signal by mixing the second RF signal with the LO signal;
generate, using the radar logic, digital values representing a beat signal using the first and second baseband signals; and
determine, using the digital values, that an environment in which the first wireless device is located has been disrupted by a presence or motion of an object.

2. The first wireless device of claim 1, wherein the beat signal indicates a delay between sending the first RF signal and receiving the reflected signals, and wherein the delay corresponds to a physical distance between the first wireless device and a location within the environment that has been disrupted by the presence or motion of the object.

3. The first wireless device of claim 1, wherein the first wireless device sends data to the second wireless device over the wireless connection using orthogonal frequency-division multiplexing (OFDM), wherein the first baseband signal is a frequency modulated continuous wave (FMCW) signal, and wherein the radar logic comprises a look-up table (LUT) comprising an offset value representing a difference between historical FMCW and OFDM power levels at a frequency or frequency range.

4. A method of operating a first wireless device, the method comprising:
at a first time, sending, using a transmit (TX) chain of radio frequency front-end (RFFE) circuitry of the first wireless device, data to a second wireless device; and
at a second time, at the first wireless device:
generating a chirp signal;
sending, using the TX chain, the chirp signal;
receiving, using a RX chain of the RFFE circuitry, reflected signals corresponding to the chirp signal;
determining, using the reflected signals and the chirp signal, a first set of digital values; and
determining, using the first set of digital values, that an environment in which the first wireless device is located has been disrupted by an object.

5. The method of claim 4, further comprising:
generating a second set of digital values;
converting, via a digital-to-analog converter (DAC) of the TX chain, the second set of digital values into a first baseband signal, wherein generating the chirp signal comprises combining the first baseband signal and a local oscillator (LO) signal;
determining a second baseband signal by removing the LO signal from the reflected signals; and
converting, via an analog-to-digital converter (ADC) of the RX chain, the second baseband signal into a third set of digital values, wherein determining the first set of digital values comprises comparing the second and third sets of digital values.

6. The method of claim 5, wherein comparing the second and third sets of digital values comprises determining a phase difference between the first and second baseband signals.

7. The method of claim 5, wherein comparing the second and third sets of digital values comprises generating a beat signal using the second and third sets of digital values, wherein the first set of digital values is the beat signal.

8. The method of claim 4, wherein the TX chain is configured for Wi-Fi® operations.

9. The method of claim 4, wherein generating the chirp signal comprises repeatedly rotating an index of a circular buffer storing a second set of digital values representing a chirp, and wherein the chirp signal comprises multiple instances of the chirp.

10. The method of claim 4, wherein determining the first set of digital values comprises:
generating a delayed chirp signal by causing the chirp signal to propagate through delay circuitry, wherein an amount of delay corresponding to the delay circuitry is associated with a distance between a first antenna and a second antenna, the first antenna being coupled to the TX chain and the second antenna being coupled to the RX chain;
extracting the delayed chirp signal from the reflected signals to generate a baseband signal; and
sending the baseband signal to an analog-to-digital converter (ADC).

11. The method of claim 4, wherein sending data to the second wireless device comprises orthogonal frequency-division multiplexing (OFDM), and wherein generating the chirp signal comprises determining an offset value representing a difference between historical frequency modulated continuous wave (FMCW) and OFDM power levels at a frequency or frequency range, the chirp signal being an FMCW signal.

12. The method of claim 4, wherein determining that the environment has been disrupted by the object comprises:
determining that a value of the first set of digital values satisfies a threshold; and
identifying, in response to determining that the value satisfies the threshold, one or more peaks of the first set of digital values.

13. A first wireless device comprising:
radio frequency front-end (RFFE) circuitry comprising a transmission (TX) chain and a receive (RX) chain; and
a baseband processor coupled to the RFFE circuitry, wherein the baseband processor is configured to:
at a first time, send data to a second wireless device using the TX chain; and
at a second time:
generate a chirp signal;
send the chirp signal using the TX chain;
receive reflected signals using the RX chain, the reflected signals corresponding to the chirp signal;
determine a first set of digital values using the reflected signals and the chirp signal; and
determine, using the first set of digital values, that an environment in which the first wireless device is located has been disrupted by an object.

14. The first wireless device of claim 13, wherein the baseband processor is further configured to:
generate a second set of digital values representing the chirp signal, wherein the second set of digital values represents the chirp signal;
receive a third set of digital values from an analog-to-digital converter coupled between the RX chain and the baseband processor, wherein the third set of digital values represents the reflected signals; and
generating the first set of digital values using the second and third sets of digital values.

15. The first wireless device of claim 14, wherein to generate the first set of digital values, the baseband processor determines a phase difference between the chirp signal and the reflected signals.

16. The first wireless device of claim 14, wherein to generate the first set of digital values, the baseband processor is to digitally dechirp the third set of digital values using the second set of digital values.

17. The first wireless device of claim 13, wherein the TX chain is configured for Wi-Fi® operations.

18. The first wireless device of claim 13, wherein a circular buffer stores a second set of digital values representing a chirp, and wherein the chirp signal comprises multiple instances of the chirp.

19. The first wireless device of claim 13, wherein the first wireless device sends data to the second wireless device via orthogonal frequency-division multiplexing (OFDM), wherein the chirp signal is a frequency modulated continuous wave (FMCW) signal, and wherein to generate the chirp signal, the baseband processor is to determine an offset value representing a difference between historical FMCW and OFDM power levels at a frequency or frequency range.

20. The first wireless device of claim 13, wherein to determine that the environment has been disrupted by the object, the baseband processor is configured to:
determine that a value of the first set of digital values satisfies a threshold; and
identify, in response to determining that the value satisfies the threshold, one or more peaks of the first set of digital values.
